(19) United States
(12) Patent Application Publication
(10) Pub. No.: US 2012/0118289 A1
(43) Pub. Date: May 17, 2012

(54) OXYGEN RESPIRATOR HAVING EMERGENCY ILLUMINATION LAMP FOR USE IN CASE OF FIRE

(76) Inventor: Oe-Hyeon Han, Gyeongsangnam-do (KR)

(21) Appl. No.: 13/384,965

(22) PCT Filed: Jul. 19, 2010
(86) PCT No.: PCT/KR2010/004702

§ 371 Date: Jan. 19, 2012

(30) Foreign Application Priority Data
Jul. 20, 2009 (KR) 10-2009-0065752

(51) Int. Cl. A62B 7/02; F21V 33/00

(52) U.S. Cl. 128/204.18

(57) ABSTRACT

The present invention relates to an oxygen respirator having an emergency illumination lamp for use in case of fire, and more specially to an oxygen respirator having an emergency illumination lamp for use in case of a fire to help people escape safely from a low visibility, oxygen-depleted area when a fire, disaster or emergency occurs. The oxygen respirator for use in case of a fire comprises: an oxygen tank having a recess on the top and storing high pressure oxygen therein; an oxygen discharge means for discharging low-pressure oxygen by passing the oxygen out of the oxygen tank through an outlet passage extended to a preset length so as to reduce the pressure of the oxygen; an oxygen respirator consisting of a nozzle attached to a lower oxygen outlet of the discharging means; and an illumination lamp including a housing with a transparent cover connected to the recess, a printed circuit board with an LED lamp inside the housing, a built-in battery provided at the lower part of the printed circuit board and an On/Off switch installed on the exterior of the housing.

### TECHNICAL FIELD

The present invention relates to an oxygen respirator having an emergency illumination lamp for use in case of a fire, and in particular to an oxygen respirator having an emergency lamp for use in case of a fire which makes it possible to help people escape safely from a low visibility, oxygen-depleted area when a fire, disaster or emergency occurs.

### BACKGROUND ART

When people are generally under an urgent, dangerous emergency situation like a fire occurs at a building or people are locked in a dark space, they panic or have a horrible fear, thus losing how to escape in safe.

There are a variety of fire or disaster prevention devices or a variety of safety equipment in the conventional art. As one of the conventional art, the Korean utility model application number 2004-19397 discloses a firefighting safe gear box designed to store, in safe, various kinds of firefighting gears. The above conventional technology will be described in brief. In the interior of a main body with a transparent cover are stored a simple fire extinguisher, an emergency illuminator, a battery, a smoke mask, etc.

The above conventional art has the disadvantages that it is hard to wear a smoke mask under an emergency situation like a fire, and a suffocation accident might occur due to smoke, and it is hard for common people to easily use various safe tools such as an emergency illuminator, a battery, etc.

### BRIEF DESCRIPTION OF THE DRAWINGS

The present invention will become better understood with reference to the accompanying drawings which are given only by way of illustration and thus are not limitative of the present invention, wherein;

FIG. 1 is a separated perspective view illustrating an oxygen respirator having an emergency illumination lamp for use in case of a fire according to a preferred embodiment of the present invention;

FIG. 2 is an internal cross sectional view illustrating an oxygen respirator having an emergency illumination lamp for use in case of a fire according to the present invention;

FIG. 3 is an internal cross sectional view illustrating an operation state of an oxygen respirator according to the present invention; and

FIG. 4 is a view illustrating a nozzle belonging to an oxygen respirator having an emergency illumination lamp for use in case of a fire according to another embodiment of the present invention.

### DISCLOSURE OF INVENTION

Accordingly, it is an object of the present invention to provide an oxygen respirator having an emergency illumination lamp for use in case of a fire which allows people to easily use an oxygen respirator while helping people to breathe in safe in a smoke space and to escape in safe in a dark space in such a way that an emergency illuminator is integrally installed at one side surface of the oxygen tank.

It is another object of the present invention to provide an oxygen respirator having an emergency illumination lamp for use in case of a fire which makes it possible for people to breathe in safe in such a way that the oxygen discharged from an oxygen respirator is designed to be discharged with a proper pressure level through a spiral discharge passage which is extended to have an enough length.

To achieve the above objects, there is provided an oxygen respirator having an emergency illumination lamp for use in case of a fire, comprising an oxygen respirator which is formed of an oxygen tank having a recess at its upper side and filled with a high pressure oxygen; an oxygen discharge part which helps the oxygen in the interior of the oxygen tank to be discharged at a certain pressure level reduced as it passes through a discharge passage extended to a certain length; and a nozzle which is attached to an outlet of oxygen at a lower side portion of the discharge part; a case having a transparent cover at the recess; a printed circuit board having a LED lamp at an inner side portion of the case; a built-in battery disposed at a lower side portion of the printed circuit board; and an illuminator having a lighting switch at an outer side portion of the case.

In addition, the oxygen discharge means comprises a pipe inserted into the interior of the oxygen tank; a rod which is inserted into the pipe for blocking its passage and has a discharge passage interconnecting an upper side hole of the pipe and an opening of its lower side portion; and an opening and closing valve which is attached to a lower side portion of the oxygen tank and opens and closes the outlet of a lower side portion of the discharge passage depending on an operation of a button disposed at its one side portion.

In addition, the discharge passage is formed in a spiral shape at an outer side surface of the rod.

### BEST MODES FOR CARRYING OUT THE INVENTION

The preferred embodiments of the present invention will be described in details with reference to the accompanying drawings. It is obvious that the preferred embodiments of the present invention are provided for the purpose that a person skilled in the art can easily understand the features of the present invention. In terms of the descriptions of the present invention, if it is assumed that the related known functions or constructions might make unclear the features of the present invention, the detailed descriptions thereon will be omitted.

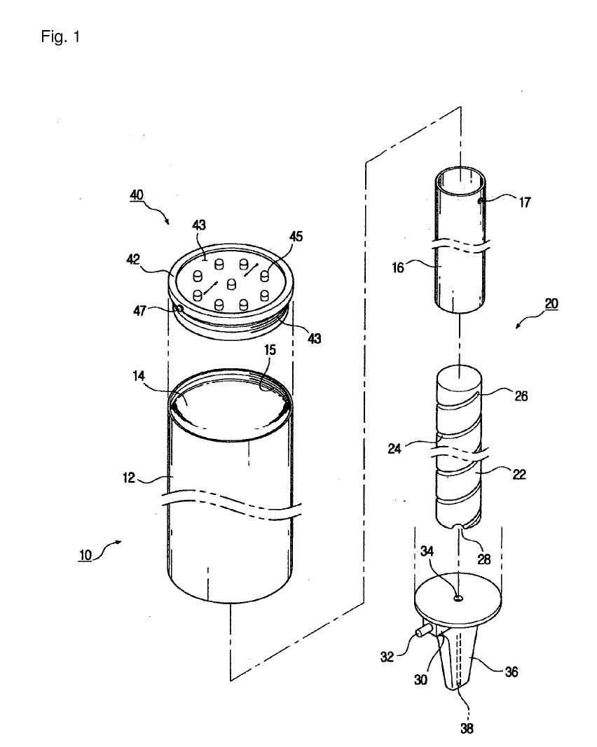

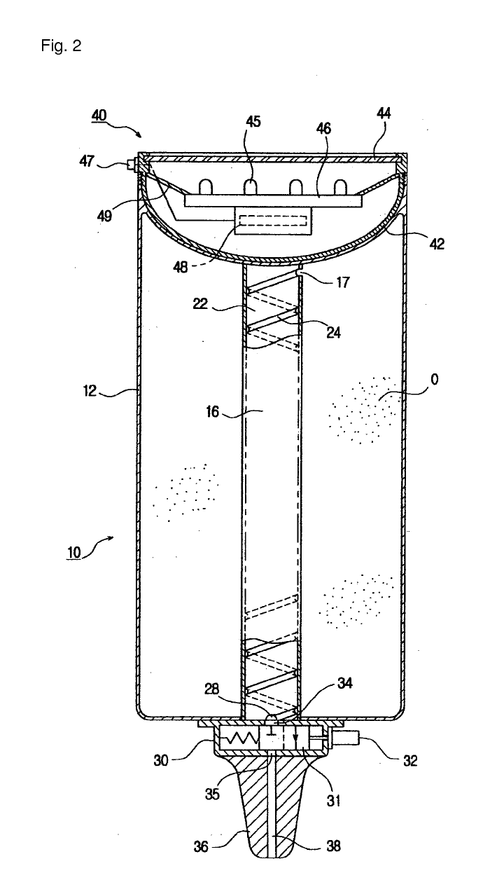

FIG. 1 is a separated perspective view illustrating an oxygen respirator having an emergency illumination lamp for use in case of a fire according to a preferred embodiment of the present invention, and FIG. 2 is an internal cross sectional view illustrating an oxygen respirator having an emergency illumination lamp for use in case of a fire according to the present invention.

As shown therein, the oxygen respirator having an emergency illumination lamp for use in case of a fire according to the present invention comprises an oxygen respirator 10 which is formed of an oxygen tank 12 having a recess 14 at its upper side and filled with a high pressure oxygen; an oxygen discharge part 20 which helps the oxygen in the interior of the oxygen tank 12 to be discharged at a certain pressure level reduced as it passes through a discharge passage 24 extended to a certain length; and a nozzle 36 which is attached to an outlet of oxygen at a lower side portion of the discharge part 20; a case 42 having a transparent cover 43 at the recess 14; a printed circuit board 46 having a LED lamp 45 at an inner side portion of the case 42; a built-in battery 48 disposed at a lower side portion of the printed circuit board 46; and an illuminator 40 having a lighting switch 47 at an outer side portion of the case 42.

In addition, the oxygen discharge mans 20 according to the present invention comprises a pipe 6 inserted into the interior of the oxygen tank 12; a rod 22 which is inserted into the pipe 16 for blocking its passage and has a discharge passage 24 interconnecting an upper side hole of the pipe 16 and an opening of its lower side portion; and an opening and closing valve 30 which is attached to a lower side portion of the oxygen tank 12 and opens and closes the outlet 28 of a lower side portion of the discharge passage 24 depending on an operation of a button 32 disposed at its one side portion.

In addition, the discharge passage 24 according to the present invention is formed in a spiral shape at an outer side surface of the rod 22.

The above construction will be described in more details.

The present invention comprises an oxygen respirator 10, and an illuminator 40 disposed at one side surface of the oxygen respirator 10. The oxygen respirator 10 is characterized in that oxygen O is filled into the interior of the oxygen tank 12 at a high pressure, and a pipe 16 is inserted into the interior from a lower side of the oxygen tank 12, and an oxygen discharge part 20 is provided at the pipe 16 for discharging oxygen. The oxygen tank 12 is characterized in that a concave recess 14 is formed at an upper side portion, so it can withstand a high pressure oxygen in its interior.

The oxygen discharge part 20 is characterized in that a pipe 16 with a rod 22 is installed at the center of the interior of the oxygen tank, and the lower side of the pipe is opened and closed by an opening and closing valve 30 attached to a lower side surface of the oxygen tank. A nozzle 36 is attached to the outlet 35 of the opening and closing valve 30 for a user to easily breathe oxygen through his mouth.

The pipe 16 is configured in such a way to have a hole 17 at its upper end portion, with its lower end portion being open as it is engaged to a lower side surface of the oxygen tank, and the rod 22 is inserted in the inner side of the pipe, thus blocking the passage. A discharge passage 24 is formed at the rod 22, and the discharge passage 24 communicates with the inlet 34 of the opening and closing valve 30 in such a way that the inlet 26 of the upper end portion is connected with the hole 17, and the outlet 28 of the lower end portion is open in a downward direction. Here, it is preferred to provide a certain guide for guiding the rod to match with the hole 17 of the inlet 26 of the discharge passage when the rod is inserted into the pipe.

Since the discharge passage 24 is extended to a certain length, the discharge pressure of the pressure of the oxygen working at a high pressure in the interior of the oxygen tank can be reduced. As shown in the drawings, it is preferred that a spiral recess might be formed along an outer surrounding surface of the rod 22, thus providing a discharge passage between the pipe and the rod. It might be formed in a zigzag shape alternately in horizontal and vertical directions.

The opening and closing valve 30 is formed of a spool valve 31 designed to return by means of an elastic member in the interior of the cylinder, and a button 32. When the button 32 is pushed, the spool valve 31 operates in leftward and rightward directions, thus switching the inlet, so the discharge passage 24 is opened or closed. When the button 32 is released, the spool valve returns to its original position by means of a recovery force of the elastic member, so the valve is closed. Here, the opening and closing valve 30 might be formed of a solenoid valve which electronically operates, thus obtaining more convenient and safe use.

The nozzle 36 has a through hole 38 connected with the outlet 35 of the opening and closing valve, thus easily sucking the discharging oxygen. It is preferred that the nozzle 36 is made from a certain smooth natural rubber, a synthetic resin, etc. which are not harmful to a human body.

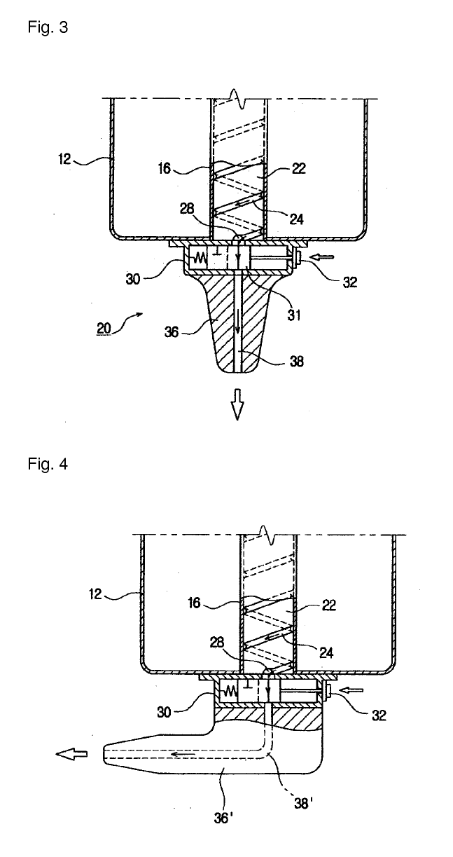

FIG. 3 is an internal cross sectional view illustrating an operation state of an oxygen respirator according to the present invention.

In the present invention, the oxygen respirator 10 according to the present invention is characterized in that when a user pushes the button 32 of the opening and closing valve 30 with the nozzle 36 bitten in his mouth, the oxygen in the interior of the oxygen tank 12 is discharged at a proper pressure level, and then the user breathes the discharging oxygen, so it is possible to prevent suffocation accident which might occur due to smoke when a fire occurs.

The illuminator 40 according to the present invention comprises a case 42 with a transparent cover 44 at its upper side, an LED lamp 45 and a printed circuit board (PCB) 46 which are disclosed in the case, a power battery 48, a reflection mirror 49 and a lighting switch 47.

The case 42 is assembled to the upper recess 14 of the oxygen tank 12 with screws 15 and 43, and the printed circuit board 46 with the LED lamp 45 is installed in the interior of the same, and the built-in battery 48 is engaged to an underside of the printed circuit board, thus supplying electric power.

In the present invention, as the illuminator 40 switches the lighting switch 47, the LED lamp 45 emits light, thus enabling the user to escape in safe from a dark space.

FIG. 4 is a view illustrating a nozzle belonging to an oxygen respirator having an emergency illumination lamp for use in case of a fire according to another embodiment of the present invention. As shown therein, the nozzle 36′ might be bent at an angle of 90° or might be arranged at a sloped angle of 30° to 45° so that the nozzle can remain horizontal in a state that the oxygen tank keeps upright for the user to easily breathe the oxygen discharged from the oxygen tank.

### INDUSTRIAL APPLICABILITY

The present invention makes it possible to fast help people to breathe oxygen with the aid of an oxygen respirator under an emergency situation as in a fire, thus preventing suffocation accidents due to smoke, and people can easily escape from a dark space, using an oxygen respirator as an illuminator.

The present invention has advantages in terms of good portability and easier storage, and anyone can easily handle with the oxygen respirator, which helps quickly cope with an emergency situation, resulting in an excellent safety.

The present invention might be used as an emergency illuminator adapting a LED lamp which illuminator has a reduced power consumption, and a reliable durability, and a long time usability, which makes it possible to effectively cope with an unexpected accident in safe.

Since the oxygen of a high pressure in the interior of the oxygen tank can be discharged with its pressure being reduced to a proper pressure level while passing through a spiral discharge passage, the oxygen can be easily sucked into a human body, which helps people breathe in an easier way.

1. An oxygen respirator having an emergency illumination lamp for use in case of a fire, comprising:
an oxygen respirator which is formed of an oxygen tank having a recess at its upper side and filled with a high pressure oxygen; an oxygen discharge means which helps the oxygen in the interior of the oxygen tank to be discharged at a certain pressure level reduced as it passes through a discharge passage extended to a certain length; and a nozzle which is attached to an outlet of oxygen at a lower side portion of the discharge means;
a case having a transparent cover at the recess;
a printed circuit board having a LED lamp at an inner side portion of the case;
a built-in battery disposed at a lower side portion of the printed circuit board; and
an illuminator having a lighting switch at an outer side portion of the case.

2. An oxygen respirator having an emergency illumination lamp for use in case of a fire according to claim 1, wherein said oxygen discharge means comprises:
a pipe inserted into the interior of the oxygen tank;
a rod which is inserted into the pipe for blocking its passage and has a discharge passage interconnecting an upper side hole of the pipe and an opening of its lower side portion; and
an opening and closing valve which is attached to a lower side portion of the oxygen tank and opens and closes the outlet of a lower side portion of the discharge passage depending on an operation of a button disposed at its one side portion.

3. An oxygen respirator having an emergency illumination lamp for use in case of a fire according to claim 1, wherein said discharge passage is formed in a spiral shape at an outer side surface of the rod.

4. An oxygen respirator having an emergency illumination lamp for use in case of a fire according to claim 2, wherein said discharge passage is formed in a spiral shape at an outer side surface of the rod.
